(19) United States
(12) Patent Application Publication
(10) Pub. No.: US 2008/0015100 A1
(43) Pub. Date: Jan. 17, 2008

(54) Hydroxylapatite Metal Composite Material and Method for the Production Thereof

(76) Inventors: Jianmin Shi, Braunschweig (DE); Ulrich Bismayer, Hannover (DE); Arndt Klocke, Hamburg (DE); Bogdan Palosz, Warszawa (PL); Stanislaw Gierlotka, Warszawa (PL)

Correspondence Address: FRIEDRICH KUEFFNER, 317 MADISON AVENUE, SUITE 910, NEW YORK, NY, 10017, US

(21) Appl. No.: 10/583,746

(22) PCT Filed: Dec. 21, 2004
(86) PCT No.: PCT/EP04/14543

§ 371 Date: May 29, 2007

(30) Foreign Application Priority Data
Dec. 23, 2003 (DE) 103 60 813.3

(51) Int. Cl. C04B 35/447; C04B 35/645

(52) U.S. Cl. 501/1; 264/667

(57) ABSTRACT

The invention relates to a hydroxylapatite metal composite material. This being, it is provided that this material is obtained by

(a) producing a mixture of powdery hydroxylapatite and powdery metal;

(b) prepressing of the mixture obtained in step (a) to a green compact and

(c) sintering of the green compact obtained in step (b) at a pressure of 1,4 to 7,7 GPa and a temperature of 500 to 900° C.

### FIELD OF APPLICATION

This invention relates to a hydroxylapatite metal composite material and a method for the production thereof.

### PRIOR ART

Metals and ceramics have been used for many years as substitutes for hard body tissue, generally for human tissue. Materials which are used for the implantation into the human body as substitutes for damaged or ill tissue must be biocompatible and have appropriate mechanical properties. The use of metal and bioinert ceramics for biomedical applications encounters many problems because of their high module of elasticity (compared with that of bones) or because of the formation of a non-adhesive fibrous capsule (the resulting movement of which can result in the prejudice to the ability to function of the implants (L. L. Hench, 1998; M. Long et al. 1998). Even bioactive ceramics are limited in their usability because of their limited mechanical properties (W. Suchanek et al. 1998). Therefore biomaterials have been developed in the last years on the base of hydroxylapatite by using particles, whiskers and long fibres as reinforcement for improving their mechanical reliability (W. Bonefield et al. 1981). Among these, metal particles are a preferred reinforcement for composite materials on hydroxylapatite base (C. Chu et al. 2002, X. Zhang et at. 1997; J. Choi et at. 1998). However no important stiffening effect has been reported. Furthermore the reactivity of a few metals, for exemple Ti, promotes the disintegration of hydroxylapatite in tribasic calcium phosphate during sintering (C. Q. Ning et at. 2002).

In U.S. Pat. No. 4,708,652 a new apatite composite ceramic is described which has the cross-linked fluorapatite structure and at least partially cristallized biologically active glass. The ceramic is obtained by reaction sintering of a powdery mixture of hydroxylapatite and biologically active glass which contains fluoridionides at a temperature of 700 to 1000° C. The composite ceramic thus obtained is supposed to have a high mechanical strength and a high biological compatibilty. However the elasticity property of such a composite ceramic is substantially based on the existence of glass. Moreover cracks cannot be completely avoided.

JP 11240782 discloses a method for producing a metal impregnated hydroxylapatite which is supposed to have a high mechanical strength. For this purpose first a tightly sintered hydroxylapatite is presintered and added with the metal into a heat and pressure resisting container. The hydroxylapatite and the metall are heated in the container under vacuum to a temperature which is situated above the melting point. For the impregnation of the hydroxylapatite with the metal, the metal is then set under pressure so that the metal penetrates into the hydroxylapatite. However due to this method no cross-linked material is obtained.

JP 200095577 describes a method for producing a hydroxylapatite metal composite material which is supposed to have a good mechanical strength, a high stability in water and a high compatibility to the human body. This method comprises the sintering of the hydroxylapatite at 700 to 1300° C. and the combination of the thus treated hydroxylapatite with a metal such as titanium by means of discharge plasma sintering at approximately 600° C. However no cross-linked material is obtained by this method either.

Both methods still have the disadvantage that the sintered materials cannot absorb cracks which are created by the mechanical stress of the material.

### Aim, Solution, Advantage

The aim of the invention is to eliminate the disadvantages according to the prior art. In particular a hydroxylapatite metal composite material should be indicated which has a high mechanical strength and a high biocompatibility. Moreover a method for producing the hydroxylapatite metal composite material as well as the use thereof are indicated.

This aim is achieved by the characteristics of the claims 1, 5 and 7. Appropriate configurations of the inventions result from the characteristics of the claims 2 to 4, 6, 8 and 9.

According to the invention, a hydroxylapatite metal composite material is provided which is obtained by
(a) producing a mixture of powdery hydroxylapatite and powdery metal;
(b) prepressing of the mixture obtained in step (a) to a green compact and
(c) sintering of the green compact obtained in step (b) at a pressure of 1,4 to 7,7 GPa and a temperature of 500 to 900° C.

The invention is based on the knowledge that the mechanical strength as well as the elasticity properties of hydroxylapatite metal composite material can be considerably improved if a metallic network which surrounds the ceramic bodies is configured in the composite material. The hydroxylapatite metal composite material according to the invention has a high mechanical strength compared to the prior art and a lower module of elasticity compared to the composite materials of the prior art so that its biocompatibility can be considerably improved. It possesses a homogeneous microstructure. The development of cracks is better avoided because of these properties.

The metal can be titanium, a precious metal such as gold or silver or a mixture of these metals. A preferred metal is titanium. For producing the hydroxylapatite metal composite material according to the invention, first a hydroxylapatite powder is made available, whereby the particle size of the hydroxylapatite powder is situated in the micrometer or nanometer range. This hydroxylapatite powder is then thoroughfully mixed with a metal powder the particle size of which is also situated in the micrometer or nanometer range and the powder mixture is prepressed in vacuum. The thus obtained prepressed green compact has been sintered under high pressure and at a high temperature during one to three minutes, which results to the infiltration of the metal and to the production of cross-linked material. The pressure for the sintering is situated between 1,4 and 7,7 GPa. The temperature during the sintering is 500 to 900° C.

The choice of a sintering time of one to three minutes avoids the disintegration of the hydroxylapatite during the sintering. Moreover it makes possible a quick manufacturing of the hydroxylapatite material composite material according to the invention.

The method according to the invention makes possible the production of a hydroxylapatite metal composite material with a cross-linked metal structure, the metal being infiltrated by high pressure and at a high temperature into the ceramic powder.

The hydroxylapatite metal composite material according to the invention can serve for the replacement and repair of a hard organic tissue even in stressed areas. It is preferably used as implant, in particular as dental implant or as bone implant. An example for a dental implant is an artifical tooth root. An example for a bone implant is an artificial bone. Furthermore the hydroxylapatite metal composite material can be used as substitute for the crown of a tooth in parts or as a whole since the material besides the implant application can also be used in the mouth as filler and for carrying out dental prosthetic work (tooth replacement).

### SHORT DESCRIPTION OF THE DRAWINGS

The invention will be explained below by referring to the attached drawings.

FIG. 1 shows a device for carrying out the method according to the invention.

FIGS. 2 to 4 show scanning electron microscopical photos of embodiments of the hydroxylapatite metal composite material according to the invention.

FIG. 5 shows X-ray diffraction diagrams of the embodiments represented in FIGS. 2 to 4.

FIG. 6 shows infrared absorption spectra of the embodiments represented in FIGS. 2 to 4.

### DETAILED DESCRIPTION OF THE INVENTION AND BEST WAY FOR CARRYING OUR THE INVENTION

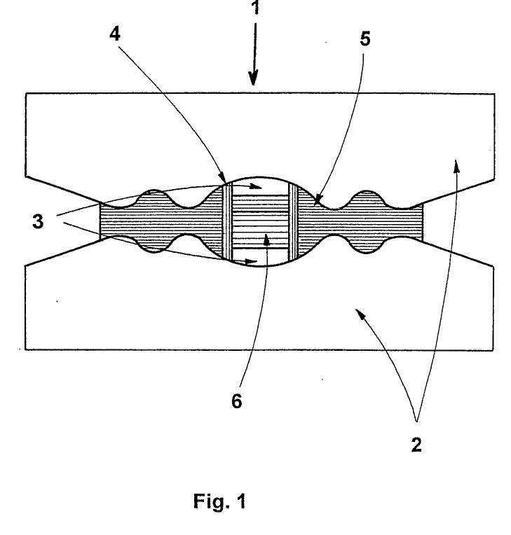

The device 1 shown in FIG. 1 has been used in order to produce the hydroxylapatite metal composite materials according to the invention. The device is a high pressure/high temperature cell. This device 1 consists of two plungers 2 between which the boron nitride pressure transmitters 3 are placed. The device has a graphite heating 4 as well as a CaCo₃ container 5. The mixture 6 of hydroxylapatite powder and metal powder is brought into the device 1 between the plungers 2 and the boron nitride pressure transmitters 3. The predetermined pressure is exerted by the plungers 2 onto the mixture.

### EXAMPLE 1

(a) Production of a Hydroxylapatite Metal Mixture

Hydroxylapatite powder (Plasma Biotal Limited, UK) with a mean particle size of 5,30 μm and titanium powder with a mean particle size of 28,90 μm have been mixed together. the mixture has then been put in hexane and the whole mixture has been mixed thoroughfully during 30 minutes in a pot mill. The thus obtained mixture has been dried in vacuum by using a dryer at 110° C. in order to remove the hexane remaining in the mixture.

(b) Production of a Green Compact

The mixture obtained in step (a) has been brought into a pressure machine and pressed to a green compact under a pressure of 20 MPa and vacuum.

(c) Sintering

The green compact obtained in step (b) has been sintered in the high pressure/high temperature cell at a pressure of 2,5 GPa at 900° C. during 2 minutes.

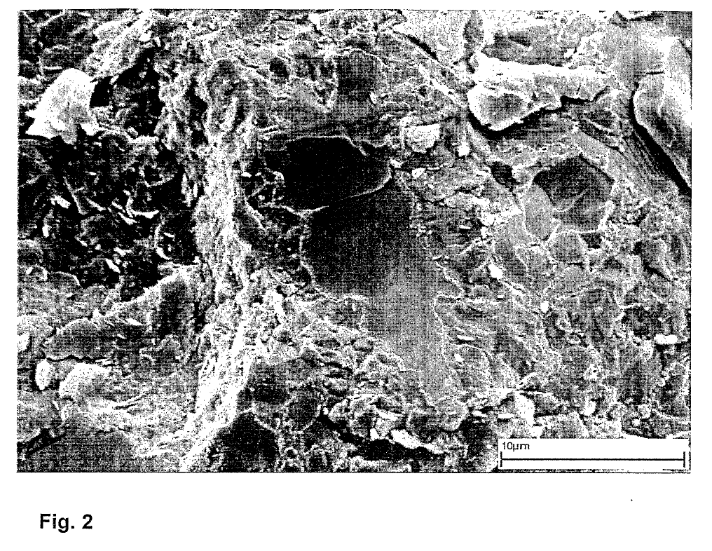

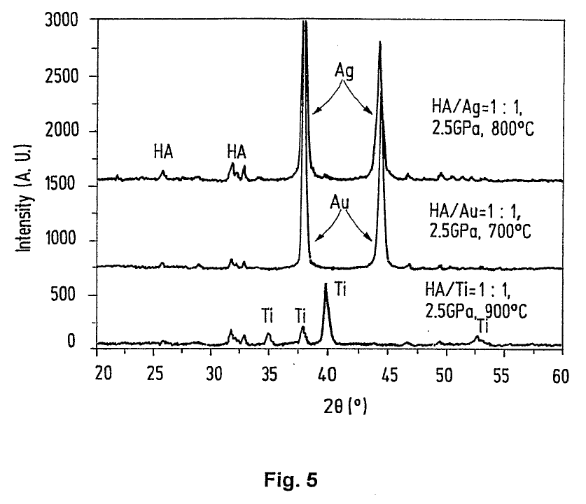

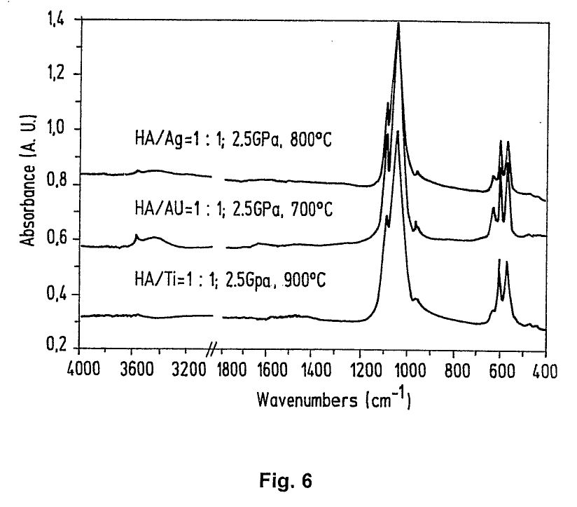

FIG. 2 shows a scanning electron microscopical photo of the thus obtained hydroxylapatite titanium composite material, whereby the hydroxylapatite phase appears white while the titanium phase appears black. The three-dimensional network structure of the composite material is clearly to be recognized on this photo which causes an improvement of the tension and pressure stability of the hydroxylapatite titanium composite material compared to the materials known until now. The X-ray diffraction diagram (in FIG. 5 designated as HA/Ti) and the infrared absorption spectrum (FIG. 6 designated as HA/Ti) show that the hydroxylapatite titanium composite material does not disintegrate during the production. The volume ratio of the hydroxylapatite to the titanium in the composite material was 1:1.

### EXAMPLE 2

The procedure described in example 1 has been repeated with the difference that gold which had a mean particle size of 28,9 μm has been used instead of titanium and that the sintering has been carried out in step (c) at a temperature of 700° C. The volume ratio of the hydroxylapatite to gold in the composite material was 1:1.

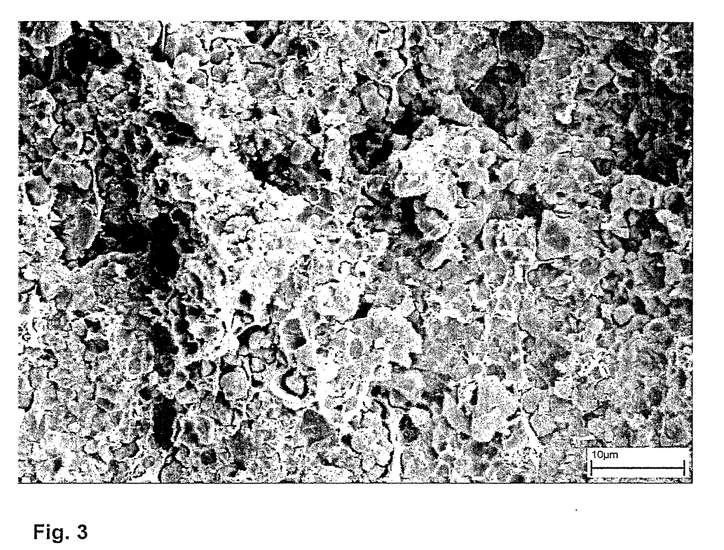

FIG. 3 shows a scanning electron microscopical photo of the thus obtained hydroxylapatite gold composite material, whereby the hydroxylapatite phase appears white while the titanium phase appears black. The three-dimensional network structure of the composite material is clearly to be recognized on this photo which causes an improvement of the tension and pressure stability of the hydroxylapatite gold composite material compared to the materials known until now. The X-ray diffraction diagram (in FIG. 5 designated as HA/Au) and the infrared absorption spectrum (FIG. 6 designated as HA/Au) show that the hydroxylapatite gold composite material does not disintegrate during the production.

### EXAMPLE 3

The procedure described in example 1 has been repeated with the difference that silver which had a mean particle size of 10,00 μm has been used instead of titanium and that the sintering has been carried out in step (c) at a temperature of 800° C. The volume ratio of the hydroxylapatite to silver in the composite material was 1:1.

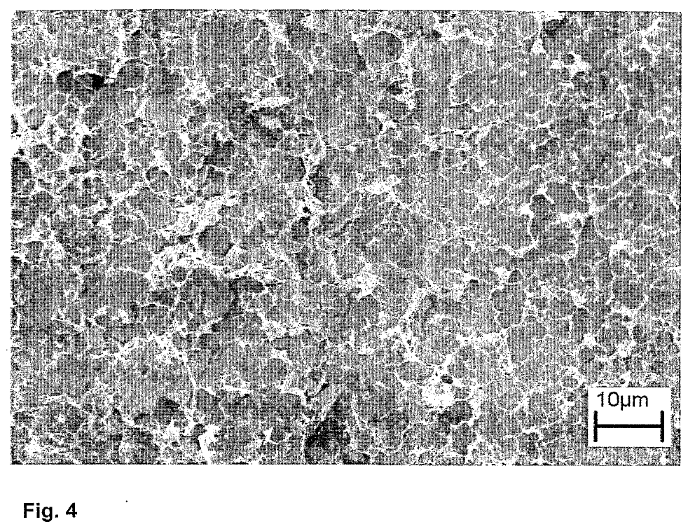

FIG. 4 shows a scanning electron microscopical photo of the thus obtained hydroxylapatite silver composite material, whereby the hydroxylapatite phase appears white while the titanium phase appears black. The three-dimensional network structure of the composite material is clearly to be recognized on this photo which causes an improvement of the tension and pressure stability of the hydroxylapatite silver composite material compared to the materials known until now. The X-ray diffraction diagram (in FIG. 5 designated as HA/Ag) and the infrared absorption spectrum (FIG. 6 designated as HA/Ag) show that the hydroxylapatite silver composite material does not disintegrate during the production.

In the claims:

1-9. (canceled)

10. A hydroxylapatite metal composite material, wherein the composite material is comprised of a metal network.

11. The hydroxylapatite metal composite material according to claim 10, wherein the metal is a precious metal or a precious metal mixture.

12. The hydroxylapatite metal composite material according to claim 11, wherein the precious metal is silver or gold.

13. The hydroxylapatite metal composite material according to claim 10, wherein the metal is titanium.

14. A method of producing a hydroxylapatite metal composite material, the method comprising constructing the composite material as a metal network, initially preparing a mixture of powdery hydroxylapatite and powdery metal, prepressing the mixture into a green compact, and sintering the green compact at a pressure of 1.4 to 7.7 GPa and a temperature og 500 to 900° C.

15. The method according to claim 14, comprising sintering the green compacts for 1 to 3 minutes.

16. The hydroxylapatite metal composite material according to claim 10, wherein the material is adapted for use as an implant.

17. The hydroxylapatite metal composite material according to claim 16, wherein the implant is a dental implant.

18. The hydroxylapatite metal composite material according to claim 16, wherein the implant is a bone implant.
